(19) United States
(12) Patent Application Publication
(10) Pub. No.: US 2024/0013760 A1
(43) Pub. Date: Jan. 11, 2024

(54) TEXT PROVIDING METHOD AND TEXT PROVIDING DEVICE

(71) Applicant: YAMAHA CORPORATION, Hamamatsu-shi (JP)

(72) Inventor: Kazuhisa AKIMOTO, Hamamatsu-shi (JP)

(21) Appl. No.: 18/471,376

(22) Filed: Sep. 21, 2023

Related U.S. Application Data
(63) Continuation of application No. PCT/JP2022/010084, filed on Mar. 8, 2022.

(30) Foreign Application Priority Data
Mar. 23, 2021 (JP) 2021-049200

(51) Int. Cl. G10H 1/38; G10H 1/00

(52) U.S. Cl. CPC G10H 1/38; G10H 1/0008; G10H 2210/571

(57) ABSTRACT

In an embodiment, a text providing method includes providing chord input data, in which chords are aligned in chronological order, to a trained model in which a relationship between chord sequence data, in which chords are aligned in chronological order, and explanatory text related to the chords included in the chord sequence data is learned, and obtaining text corresponding to the chord input data from the trained model.

### CROSS-REFERENCE TO RELATED APPLICATION

This application is a Continuation of International Patent Application No. PCT/JP2022/010084, filed on Mar. 8, 2022, which claims the benefit of priority to Japanese Patent Application No. 2021-049200, filed on Mar. 23, 2021, the entire contents of which are incorporated herein by reference.

### FIELD

The present disclosure relates to a text providing method and a text providing device.

### BACKGROUND

A plurality of chords constituting a piece of music changes an impression given to a listener by a combination thereof (for example, chord progression arranged in chronological order). General listeners receive an impression of the music intuitively. The listener can confirm the impression of the music by analyzing the music based on music theory such as chord progression. A technique of detecting cadence in a music score indicating chord progression of a piece of music, displaying an arrow symbol in a cadence part, and changing a color in a display according to a type of cadence is disclosed in, for example, Japanese Laid-Open Patent Publication No. 2020-56938. A user can recognize a part of the chord included in the music corresponding to the cadence and the type of the cadence by the arrow symbol and the color.

### SUMMARY

According to an embodiment of the present disclosure, there is provided a text providing method including obtaining text corresponding to chord input data in which chords are aligned in chronological order, based on a relationship between chord sequence data, in which chords are aligned in chronological order, and explanatory text related to the chords included in the chord sequence data.

According to an embodiment of the present disclosure, there is provided a text providing device including a control unit including a processor and a memory. The control unit is configured to obtain a text corresponding to chord input data in which chords are aligned in chronological order, based on a relationship between chord sequence data, in which chords are aligned in chronological order, and explanatory text related to the chords included in the chord sequence data.

### BRIEF DESCRIPTION OF DRAWINGS

FIG. 1 is a diagram showing a text providing system according to an embodiment.

FIG. 2 is a flowchart showing a text providing process according to an embodiment.

FIG. 3 is a diagram for describing a chroma vector representing a chord according to an embodiment.

FIG. 4 is a diagram for describing a chroma vector representing a chord according to an embodiment.

FIG. 5 is a diagram for explaining an example of explanatory text obtained from chord input data.

FIG. 6 is a flowchart showing a model generating process according to an embodiment.

FIG. 7 is a diagram for explaining an example of a teacher data set.

FIG. 8 is a diagram for explaining an example of a teacher data set.

FIG. 9 is a diagram for explaining an example of a teacher data set.

FIG. 10 is a diagram for explaining a chord progression detected as II-V-I.

FIG. 11 is a diagram for explaining an example of explanatory text obtained from chord input data.

FIG. 12 is a diagram for explaining an example of explanatory text obtained from chord input data.

FIG. 13 is a diagram for describing a modification of the chord progression detected as II-V-I.

FIG. 14 is a diagram for describing a modification of the chord progression detected as II-V-I.

FIG. 15 is a diagram for explaining a music database according to an embodiment.

FIG. 16 is a diagram for explaining a method of calculating a chord progression importance level.

FIG. 17 is a flowchart showing a process of generating chord input data according to an embodiment.

### DESCRIPTION OF EMBODIMENTS

There are various types of chord progression included in music. Understanding the type of chord progression is an important factor that supports the impression of a song. According to the technique described in Japanese Laid-Open Patent Publication No. 2020-56938, a user can recognize a part and a type of cadence included in a musical score of a piece of music, based on image information such as an arrow symbol and a color. However, if the user does not have a certain degree of knowledge of music theory, the user cannot understand the meaning based on the image information, and cannot utilize the obtained information.

According to the present disclosure, it is possible to provide an explanatory text related to a chord, based on a plurality of chords aligned in chronological order.

Hereinafter, an embodiment of the present disclosure will be described in detail with reference to the drawings. The following embodiments are examples, and the present disclosure should not be construed as being limited to these embodiments. In the drawings referred to in the present embodiment, the same or similar parts are denoted by the same reference signs or similar reference signs (only denoted by A, B, or the like after a numeral), and repetitive description thereof may be omitted.

### 1-1. Text Providing System

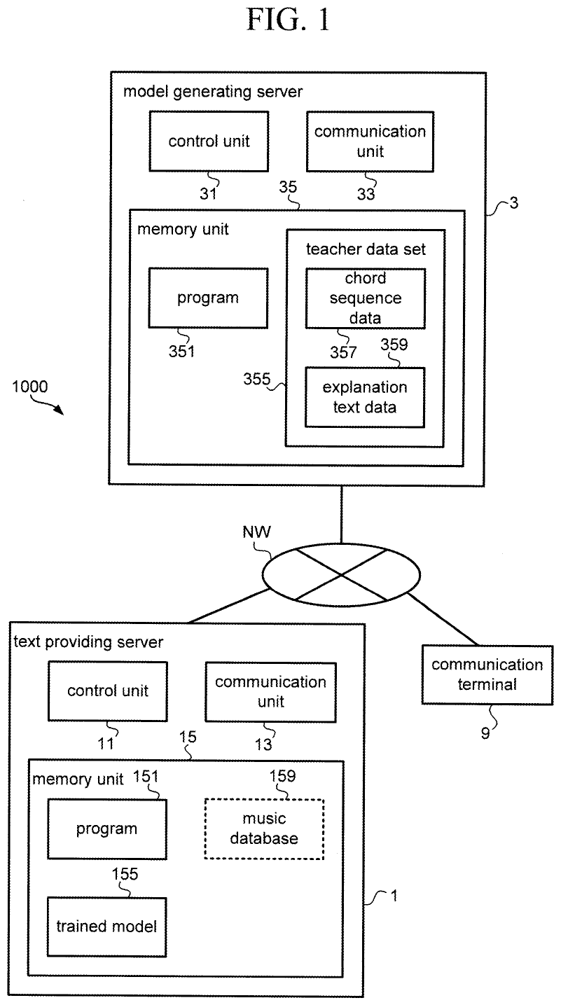

FIG. 1 is a diagram showing a text providing system according to an embodiment. A text providing system 1000 includes a text providing server 1 (text providing device) and a model generating server 3 connected to a network NW such as the Internet. A communication terminal 9 is a smart phone, a tablet personal computer, a laptop personal computer, a desktop personal computer, or the like, and is connected to the networked NW to perform data communication with other devices.

The text providing server 1 receives data related to music from the communication terminal 9 via the network NW, and transmits explanatory text corresponding to a chord progression included in the music to the communication terminal 9. In the communication terminal 9, the explanatory text can be displayed on a display. The text providing server 1 generates explanatory text using a trained model obtained by a machine learning. A trained model 155 receives chord input data in which chords constituting a piece of music are aligned in chronological order, and outputs explanatory text related to the chord progression by an arithmetic process using a neural network. The model generating server 3 executes the machine learning process using a teacher data set to generate the trained model to be used in the text providing server 1. Hereinafter, the text providing server 1 and the model generating server 3 will be described.

### 1-2. Text Provision Server

The text providing server 1 includes a control unit 11, a communication unit 13, and a memory unit 15. The control unit 11 includes a CPU (processor), a RAM, and a ROM. The control unit 11 executes a program stored in the memory unit by the CPU to perform a process according to an instruction described in the program. The program includes a program 151 for performing a text providing process to be described later.

The communication unit 13 includes a communication module, and is connected to the networked NW to transmit and receive various types of data to and from other devices.

The memory unit 15 includes a memory device such as a nonvolatile memory, and stores the program 151 and the trained model 155. In addition, various data used in the text providing server 1 is stored. The memory unit 15 may store a music database 159. The music database 159 is described in another embodiment. The program 151 should be executable by a computer, and may be provided to the text providing server 1 in a state of being stored in a computer-readable recording medium such as a magnetic recording medium, an optical recording medium, a magneto-optical recording medium, or a semiconductor memory. In this case, the text providing server 1 should include a device for reading the recording medium. The program 151 may be provided by downloading via the communication unit 13.

The trained model 155 is generated by the machine learning in the model generating server 3 and provided to the text providing server 1. When the chord input data is input, the trained model 155 outputs the explanatory text related to the chord by the arithmetic process using the neural network. In this embodiment, the trained model 155 is a model using RNN (Recurrent Neural Network). The trained model 155 utilizes Seq2Seq (Sequence To Sequence), that is, an encoder and a decoder are included as described below. The chord input data and the explanatory text are examples of data described in chronological order, and will be described in detail later. Therefore, it is preferable that the trained model 155 adopts a model that is advantageous for handling time-series data.

The trained model 155 may be a model using LSTM (Long Short Term Memory) or GRU (Gated Recurrent Unit). The trained model 155 may be a model using CNN (Convolutional Neural Network), Attention (Self-Attention, Source Target Attention), and the like. The trained model 155 may be a model in which a plurality of models is combined. The trained model 155 may be stored in another device connected via the network NW. In this case, the text providing server 1 may be connected to the trained model 155 via the network NW.

### 1-3. Model Generating Server

The model generating server 3 includes a control unit 31, a communication unit 33, and a memory unit 35. The control unit 31 includes a CPU (processor), a RAM, and a ROM. The control unit 31 executes a program stored in the memory unit 35 by the CPU to perform a process according to an instruction described in the program. The program includes a program 351 for performing a model generating process to be described later. The model generating process is a process for generating the trained model 155 using a teacher data set 355.

The communication unit 33 includes a communication module, and is connected to the network NW to transmit and receive various types of data to and from other devices.

The memory unit 35 includes a memory device such as a non-volatile memory, and stores the program 351 and the teacher data set 355. In addition, various data used in the model generating server 3 is stored. The program 351 may be executable by a computer, and may be provided to the model generating server 3 in a state of being stored in a computer-readable recording medium such as a magnetic recording medium, an optical recording medium, a magneto-optical recording medium, or a semiconductor memory. In this case, the text providing server 1 should include a device for reading the recording medium. The program 351 may be provided by downloading via the communication unit 33.

A plurality of teacher data sets 355 may be stored in the memory unit 35. The teacher data set 355 is data in which chord sequence data 357 and explanatory text data 359 are associated with each other, and is used for generating the trained model 155. Details of the teacher data set 355 will be described later.

### 2. Text Providing Process

Next, a text providing process (text providing method) executed by the control unit 11 of the text providing server 1 will be described. The text providing process is started, for example, in response to a request from the communication terminal 9.

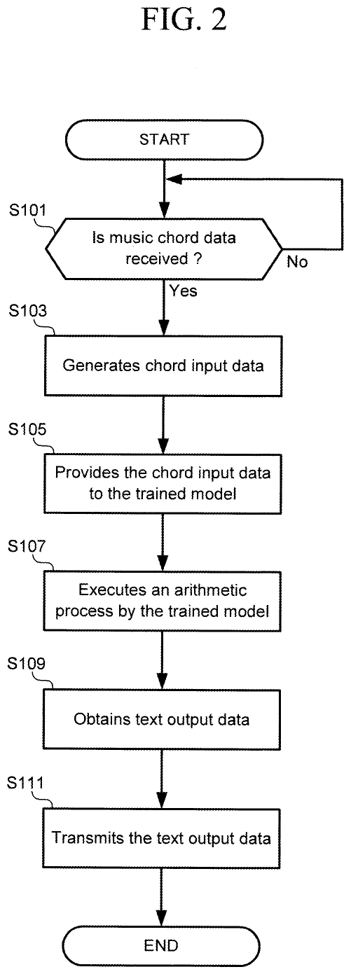

FIG. 2 is a flowchart showing a text providing process according to an embodiment. The control unit 11 waits until music chord data is received from the communication terminal 9 (step S101; No). The music chord data is data in which a plurality of chords constituting a piece of music are aligned in chronological order and described. For example, the music chord data is described as “CM7-Dm7-Em7- . . . ”. In the case where the chords are aligned in chronological order, the chords may be aligned in a predetermined unit period (for example, one bar, one beat, or the like) as a unit, or may be aligned in order without considering the unit period. For example, assuming that each chord in the example described above is aligned in a unit of one bar, when the first chord in the example described above continues for two bars, the music chord data is described as “CM7-CM7-Dm7 . . . ”. On the other hand, assuming that the number of bars is not considered, the music chord data is described as “CM7-Dm7- . . . ” as in the example described above.

When the user operates the communication terminal 9 to instruct transmission of the music chord data, the communication terminal 9 transmits the music chord data to the text providing server 1. When the text providing server 1 receives the music chord data, the control unit 11 generates chord input data from the music chord data (step S103). The chord input data is described by converting each chord included in the music chord data into a predetermined format. Specifically, the chord input data is data in which each chord is described by a chroma vector.

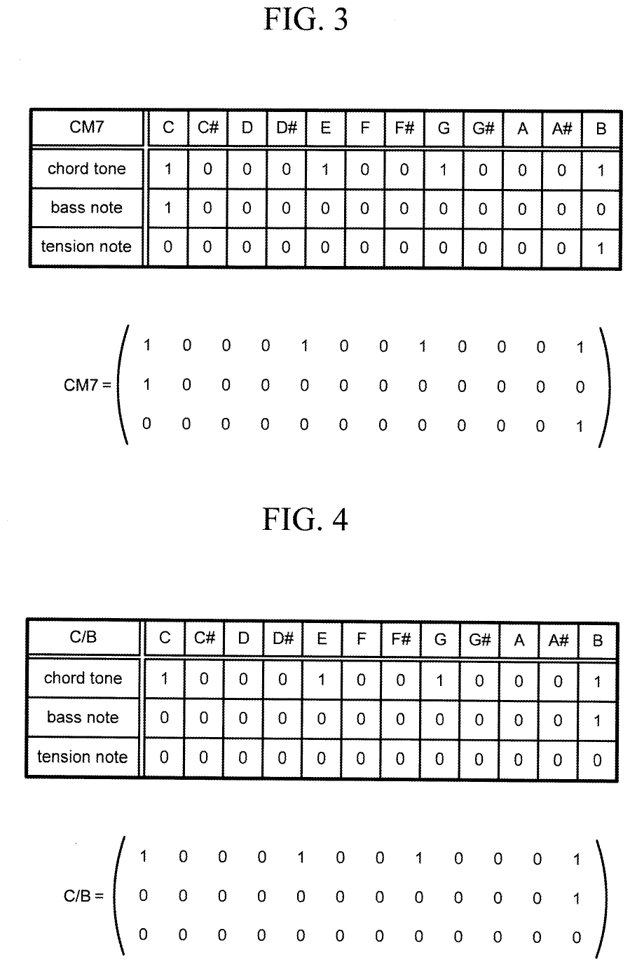

FIG. 3 and FIG. 4 are diagrams for describing a chroma vector representing a chord in an embodiment. As shown in FIG. 3 and FIG. 4, the chroma vector is described by the presence “1” or absence “0” of sound corresponding to each sound name (C, C #, D, . . . ). In this example, each chord is converted into data (hereinafter referred to as converted data) which is a combination of a chroma vector corresponding to a chord tone, a chroma vector corresponding to a bass note, and a chroma vector corresponding to a tension note. In this example, the converted data is data in which three chroma vectors are described as matrix data (3×12). The converted data may be described as vector data in which the three chroma vectors are connected in series.

FIG. 3 is a diagram showing a chord “CM7” as the converted data. FIG. 4 is a diagram showing a chord “C/B” as the converted data. The chords “CM7” and the “C/B” have the same chord tone, but differ from each other in the bass note and the tension note. Therefore, according to the converted data, it is possible to distinguish between “CM7” and “C/B”. That is, the converted data can clearly represent a function of the chord. The converted data may include at least the chroma vector of the chord tone, and may not include at least one or both of the bass note and the tension note. A structure of the converted data may be appropriately set according to a required result.

The chord input data is data obtained by aligning the converted data in chronological order. As described above, when the music chord data is “CM7-Dm7- . . . ”, the chord input data is described as data aligned in the order of the converted data corresponding to “CM7”, the converted data corresponding to “Dm7”, . . .

Returning to FIG. 2, the description will be continued. The control unit 11 provides the chord input data to the trained model 155 (step S105). The control unit 11 executes an arithmetic process by the trained model 155 (step S107), and obtains text output data from the trained model 155 (step S109). The control unit 11 transmits the obtained text output data to the communication terminal 9 (step S111). The text output data corresponds to the explanatory text described above, and includes a character group indicating an explanation on a chord defined by the chord input data. The explanatory text includes at least one of a first character group describing a chord progression, a second character group describing the function of the chord, and a third character group describing a concatenation technique between chords. In this example, the explanatory text includes the first character group, the second character group, and the third character group.

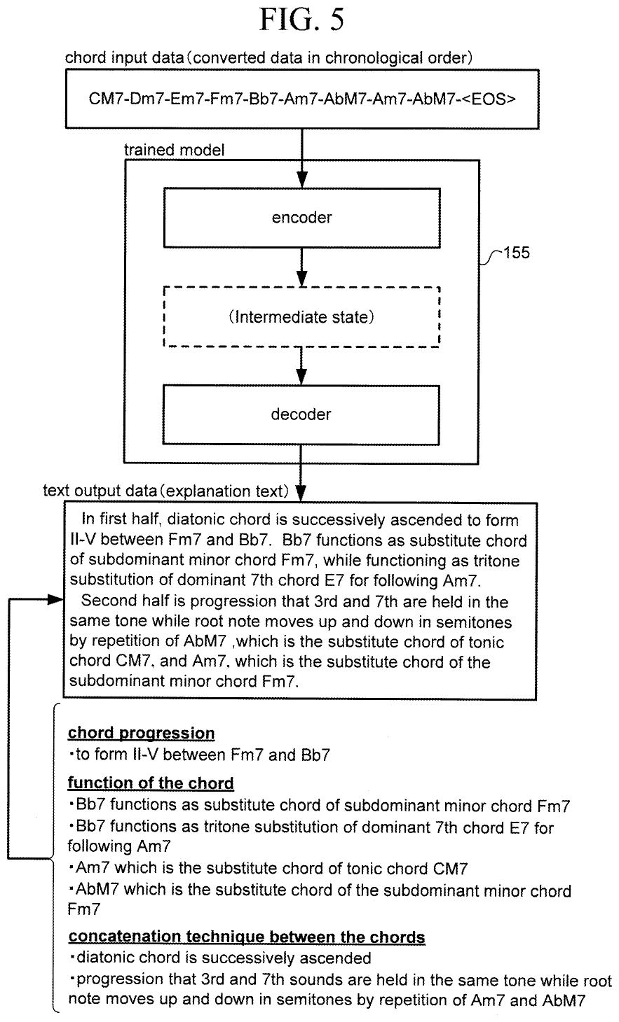

FIG. 5 is a diagram for explaining an example of explanatory text obtained from the chord input data. The trained model 155 includes an encoder (also referred to as an input layer) that generates data in an intermediate state by calculating the provided chord input data by RNN, and a decoder (also referred to as an output layer) that outputs the text output data by calculating the data in the intermediate state by RNN. More specifically, the encoder is provided with a plurality of pieces of converted data included in the chord input data in chronological order. The decoder outputs a plurality of characters (character groups) aligned in chronological order as the explanatory text. The term “character” as used herein may mean a single word (morpheme) classified by morphological analysis. The intermediate state may also be referred to as a hidden state or a hidden layer.

The chord input data shown in FIG. 5 is shown as the music chord data “CM7-Dm7-Em7- . . . ” for convenience, but is data in which the respective chords are described as the converted data as described above. In the chord input data, an end marker (EOS: End Of Sequence) is provided to an end part of the chord. When the chord input data is provided to the trained model 155, the trained model 155 outputs text output data including the explanatory text shown in FIG. 5. According to the chord input data shown in FIG. 5, the text output data, that is, the explanatory text is constituted by a combination of the following character groups. “In first half, diatonic chord is successively ascended to form II-V between Fm7 and Bb7. Bb7 functions as a substitute chord of a subdominant minor chord Fm7, while functioning as a tritone substitution of dominant 7th chord E7 for following Am7. Second half is a progression that 3rd and 7th are held in the same tone while the root note moves up and down in semitones by repetition of AbM7, which is the substitute chord of tonic chord CM7, and Am7, which is the substitute chord of the subdominant minor chord Fm7.”

In the explanatory text shown in FIG. 5, the first character group (explaining the chord progression) corresponds to “to form II-V between Fm7 and Bb7”.

The second character group (describing the function of the chord) in the explanatory text shown in FIG. 5 corresponds to “Bb7 functions as a substitute chord of the subdominant minor chord Fm7”, “Bb7 functions as a tritone substitution of the dominant 7th chord E7 for following Am7”, “Am7 which is the substitute chord of the tonic chord CM7”, and “AbM7 which is the substitute chord of the subdominant minor chord Fm7”. Actually, in the explanatory text, an explanation of two functions related to Bb7 are summarized and expressed as “Bb7 functions . . . while functioning . . . for following Am7.”

Among the explanatory text shown in FIG. 5, the third character group (explanation of the concatenation technique between the chords) corresponds to “diatonic chord is successively ascended” and “progression in which 3rd and 7th sounds are held at the same tone while root note moves up and down in semitones by repetition of Am7 and AbM7”. In practice, in the explanatory text, the successive ascending of the diatonic chord is expressed as “diatonic chord is successively ascended . . . ” so as to be connected to the next text.

The text output data thus obtained is transmitted to the communication terminal 9 that has transmitted the music chord data. Thus, the user of the communication terminal 9 is provided with explanatory text corresponding to the music chord data. The above is the description of the text providing process.

### 3. Model Generating Process

Next, a model generating process (model generating method) executed by the control unit 31 of the model generating server 3 will be described. The model generating process is started in response to a request from a terminal or the like used by an administrator of the model generating server 3. The model generating process may be started in response to a request from the user, that is, the request from the communication terminal 9.

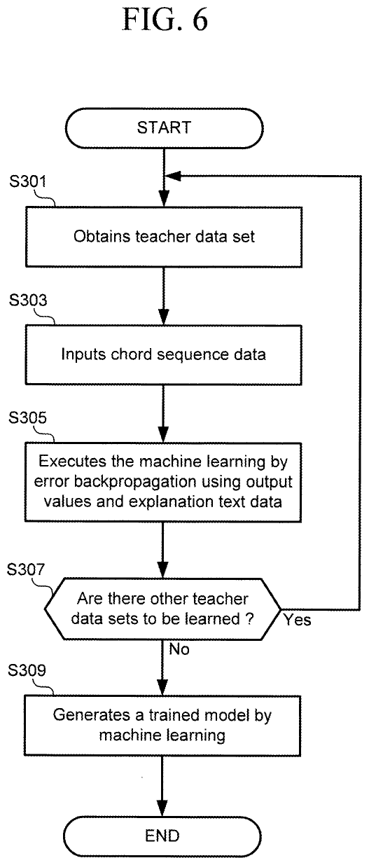

FIG. 6 is a flowchart showing a model generating process according to an embodiment. The control unit 31 obtains the teacher data set 355 from the memory unit 35 (step S301). As described above, the teacher data set 355 includes chord sequence data 357 and explanatory text data 359 associated with each other. The chord sequence data 357 is described in the same format as the chord input data. That is, the chord sequence data 357 is described as data in which chords represented by the converted data are aligned in chronological order.

The explanatory text data 359 is data including explanatory text as shown in FIG. 5. This explanatory text is a text explaining the chord defined by the chord sequence data 357. The explanatory text includes at least one of the first character group explaining the chord progression, the second character group explaining the function of the chord, and the third character group explaining the concatenation technique between the chords, as described above. In this example, the explanatory text data 359 is provided with an identifier for identifying a word obtained by dividing the explanatory text by the morphological analysis. Each word is described in “One Hot Vector”. The explanatory text may be described in terms of words such as “word2vec” and “GloVe”.

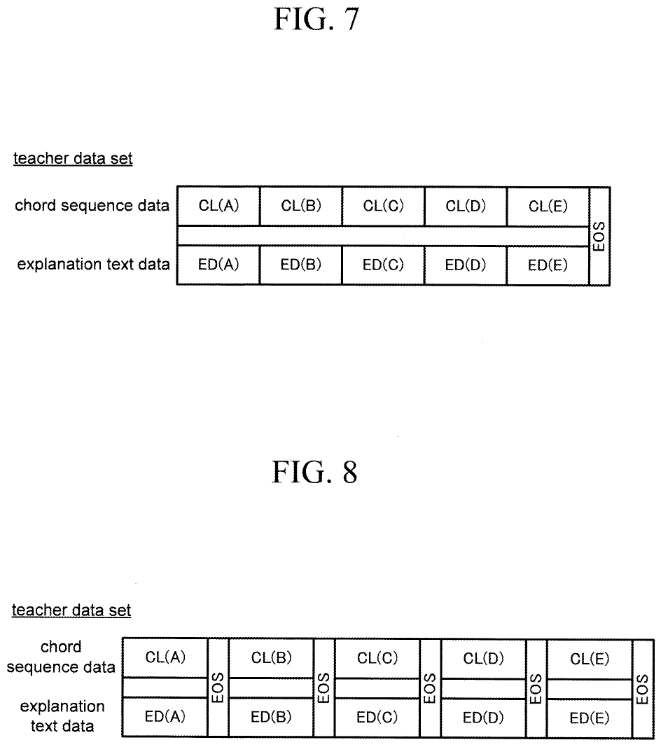

The chord sequence data 357 included in the teacher data set 355 includes a sequence of chords corresponding to a piece of music in this example, and has at least one termination marker EOS. The teacher data set 355 may take various forms. A plurality of examples of the form that the teacher data set 355 may take will be described with reference to FIG. 7 to FIG. 9.

FIG. 7 to FIG. 9 are diagrams for explaining an example of a teacher data set. In the teacher data set 355 described here, the chord sequence data 357 corresponding to the chord of the music is indicated by a plurality of sections (music sections CL(A) to CL(E)). Here, the music sections CL(A) to CL(E) respectively correspond to a segmented range such as a phrase constituting a piece of music, for example, a range of 8-bar units, and each includes a plurality of chords aligned in chronological order. Each music section may not have the same length as the other music sections.

The chord sequence data 357 shown in FIG. 7 has a format in which a series of chords corresponding to the music sections CL(A) to CL(E) are described, and includes the end marker EOS only at an end of the data.

The chord sequence data 357 in FIG. 8 has a format in which the chords corresponding to the music sections CL(A) to CL(E) are divided and described for each music section. At a division position, the end marker EOS is described. The section divided by the end marker EOS is referred to as a divided region. A plurality of music sections may be included in one divided region. On the other hand, in this example, one music section is not included in a plurality of divided regions.

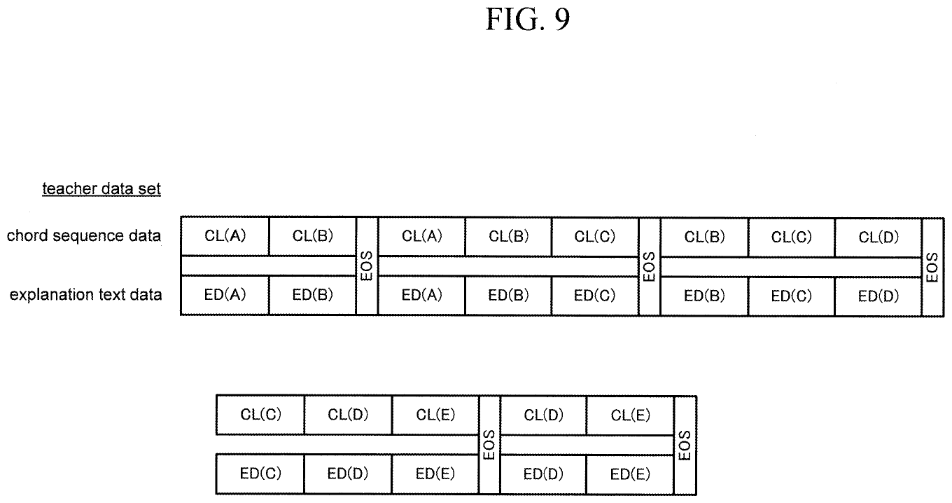

The chord sequence data 357 in FIG. 9 has a format in which the chords corresponding to the music sections CL(A) to CL(E) are divided for each music section as shown in FIG. 8, and then chords of the music sections before and behind the music sections are further added in the respective divided regions. That is, in the chord sequence data 357 in FIG. 9, a plurality of music sections that are consecutive to one divided region are arranged, and at least one music section is included in the plurality of divided regions. In this example, three consecutive music sections are arranged in each divided region, and two consecutive music sections are arranged only in first and last divided regions. A number of consecutive music sections is not limited to this example.

The explanatory text data 359 includes explanatory texts ED(A) to ED(E) corresponding to the music sections CL(A) to CL(E), respectively. For example, the explanatory text ED(A) includes a character group describing the chord corresponding to the music section CL(A). The explanatory text data 359 shown in FIG. 8 and FIG. 9 is divided by the end marker EOS in the same manner as the chord sequence data 357.

Returning to FIG. 6, the description will be continued. The control unit 31 inputs the chord sequence data 357 into a model for the machine learning (here, referred to as a training model) (step S303). The training model is a model that performs an arithmetic process using the same neural network (RNN in this example) as the trained model 155. The training model may be the trained model 155 stored in the text providing server 1.

The control unit 31 executes the machine learning by error backpropagation using the values output from the training model and the explanatory text data 359 in response to inputting the chord sequence data (step S305). Specifically, a weight coefficient in the neural network of the training model is updated by the machine learning. If there are other teacher data sets 355 to be learned (step S307; Yes), the machine learning is performed using the rest of teacher data sets 355 (step S301, S303, and S305). In the case where there is no other teacher data set 355 to be learned (S307 step; No), the control unit 31 ends the machine learning.

The control unit 31 generates a training model that has already been machine learned as a trained model (step S309), and ends the model generating process. The generated trained model is provided to the text providing server 1 and used as the trained model 155. As described above, the trained model 155 is a model in which a correlation between the chord defined in the chord sequence data 357 and the explanatory text related to the chord is learned.

In the case where the chord sequence data 357 input in the machine learning includes the end marker EOS in the middle of the data as shown in FIG. 8 and FIG. 9, the control unit 31 resets the intermediate status at the time of the end marker EOS. That is, in the machine learning, a chord in a specific divided region and a chord in another divided region divided from the specific divided region are not treated as consecutive chronological data. In the example shown in FIG. 8, a chord in a specific music section and a chord in a music section different from the music section are respectively treated as time-series data independent of each other. On the other hand, chords included in one music section are treated as time-series data.

In an example shown in FIG. 9, the music sections separated from each other, for example, the music section CL(B) and the music section CL(E) are not included in one divided region, and are respectively treated as time-series data that are independent of each other. On the other hand, the music section CL(B) and the music section CL(C) may be included in one divided region or may be included in separate divided regions. Therefore, the chord of the music section CL(B) and the chord of the music section CL(C) may be treated as a series of time-series data or time-series data independent of each other.

The three shown teacher data sets are summarized as follows. The first example is a teacher data set in which a divided region is not set as shown in FIG. 7. The second example is a teacher data set in which a plurality of divided regions is set as shown in FIG. 8, and no music section is included in the plurality of divided regions. The third example is a data set in which the plurality of divided regions is set as shown in FIG. 9, and at least one music section is included in the plurality of divided regions.

In particular, as in the first example and the third example, by increasing the number of chords treated as time-series data, it is possible to realize highly accurate machine learning including a before and after relationship of an order of chords is widely taken into consideration. As in the third example, by narrowing down a range of the before and after relationship, it is possible to exclude parts that are too far apart from each other and have a weak relationship from the object of machine learning, and to realize machine learning with higher accuracy. In the machine learning, only one of these examples may be used, or a plurality of examples may be used in combination.

### 4. Example of Chord Interpretation

Next, a correlation between a chord interpretation and the explanatory text will be described in more detail. Here, an example in which II-V-I is detected as an example of a typical chord progression will be described.

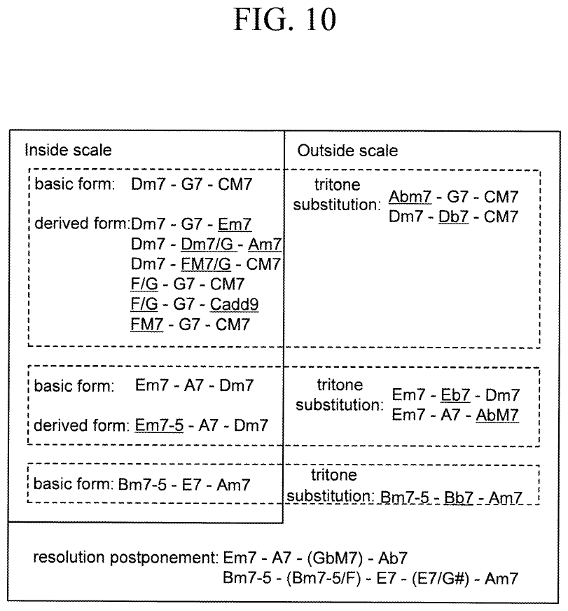

FIG. 10 is a diagram for explaining a chord progression detected as II-V-I. In FIG. 10, examples within a scale of Cmaj or Amin (basic form and derived form) and other examples outside the scale (tritone substitution and resolution postponement) are shown as the chord progression of II-V-I. “Tritone substitution” means that the tritone substitution is utilized in a part of the chord progression. A derived form and a tritone substitution corresponding to the basic form are enclosed in a single region by a dashed line. In the derived form and the tritone substitution, parts different from the basic form are underlined. “Resolution postponement” is an example in which a change is made by inserting the chord shown in ( ) while taking the form of II-V-I.

The trained model 155 generated by the machine learning described above can output as explanatory text that II-V-I exists even in the case of a chord progression expressed in a form other than the basic form. In some cases, an order of chords constituting a piece of music accidentally includes a chord progression corresponding to II-V-I without intending to be II-V-I. Even in such a case, the trained model 155 generated by the machine learning considering a before and after relationship of an order of chords can output explanatory text considering whether or not the chord progress corresponds to II-V-I.

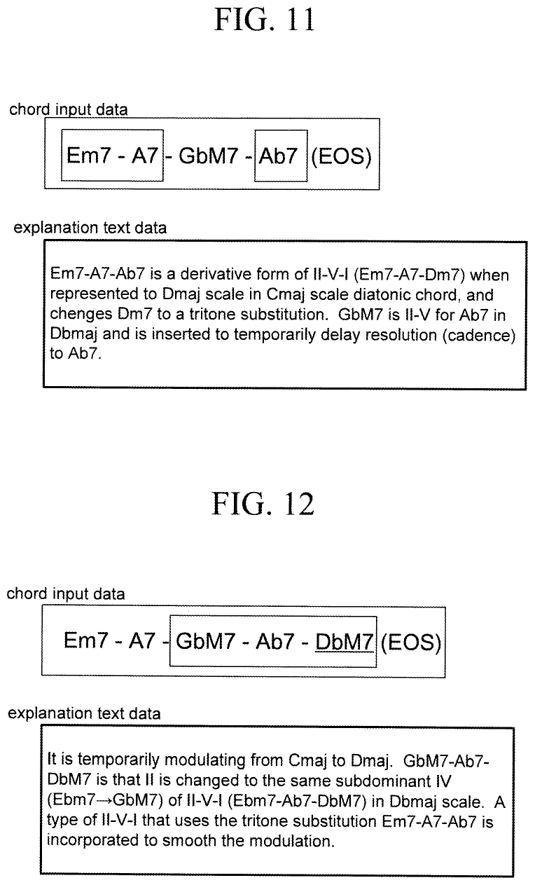

FIG. 11 and FIG. 12 are diagrams for explaining an example of explanatory text obtained from chord input data. Both FIG. 11 and FIG. 12 are provided with a sequence of chords “Em7-A7-GbM7-Ab7”, but in FIG. 12 DbM7 is further added to a last part. That is, a chord located at the end of the time series by the end marker EOS is Ab7 in FIG. 11, whereas it is DbM7 in FIG. 12.

The trained model 155 estimates that an element “Em7-A7-Ab7” in the chord input data shown in FIG. 11 is related to II-V-I, and outputs the following explanatory text as the text output data.

“In a diatonic chord of the Cmaj scale, Em7-A7-Ab7 is a derivative form of II-V-I (Em7-A7-Dm7) in the Dmaj scale, and changes Dm7 to a tritone substitution. GbM7 is II-V for Ab7 in Dbmaj and is inserted to temporarily delay resolution (cadence) to Ab7.”

On the other hand, the trained model 155 estimates that an element of “GbM7-Ab7-DbM7” in the chord input data shown in FIG. 12 is related to II-V-I, and further, outputs the following explanatory text referring to an element of “Em7-A7-Ab7” as the text output data. “It is temporarily modulating from Cmaj to Dmaj. GbM7-Ab7-DbM7 is that II is changed to the same subdominant IV (Ebm7→GbM7) of II-V-I (Ebm7-Ab7-DbM7) in the Dbmaj scale. A type of II-V-I that uses the tritone substitution Em7-A7-Ab7 is incorporated to smooth the modulation.”

As described above, by performing the machine learning using the many teacher data sets 355, even if a sequence of chords included in the chord input data is similar, the trained model 155 can output text output data including an appropriate explanatory text in consideration of a before and after relationship of the similar part.

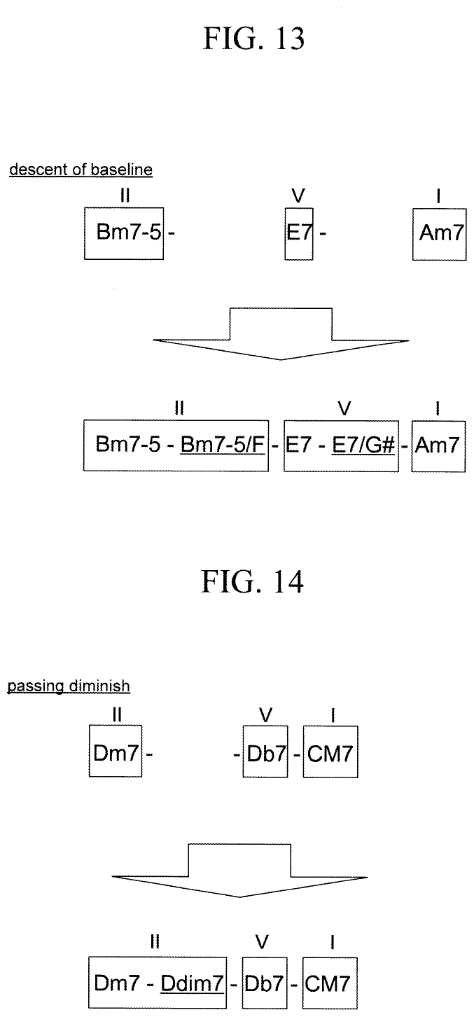

FIG. 13 and FIG. 14 are diagrams for explaining a modified example of a chord progression detected as II-V-I. In the example shown in FIG. 13, when a concatenation technique called a descent of the baseline is applied to the “Bm7 (-5)-E7-Am7” which is a basic form of the II-V-I chord progression, the chords are aligned as, for example, “Bm7(-5)-BM7(-5)/F-E7-E7/G #-AM7”. Even in this case, it is possible to recognize that the chord progression is II-V-I without being affected by the change in the baseline.

In the example shown in FIG. 14, when a concatenation technique called passing diminished is applied to “Dm7-Db7-CM7” which is a basic form of a II-V-I chord progression, the chords are aligned as, for example, “Dm7-Ddim7-Db7-CM7”. Even in this case, it is possible to recognize that the chord progression is a II-V-I chord progression without being affected by the addition of Ddim7.

### 5. Extraction of Specific Section

In the embodiment described above, the chord input data may specify a sequence of all the chords included in the music chord data, or may specify a sequence of some of the chords extracted from the sequence of all the chords. In the following description, a section of a piece of music corresponding to a chord included in chord input data is referred to as a specific section. The specific section may be set by the user or may be set by a predetermined method exemplified below.

An example of a predetermined method will be described. The chord input data provided to the trained model 155 may not be all of the music chord data, and if a characteristic part of a piece of music can be used, a characteristic explanatory text corresponding to the piece of music can be obtained. Therefore, it is preferable to set such a characteristic part of the music as a specific section. The characteristic part of the music can be set in various ways, and an example thereof will be described.

In the example described here, the control unit 11 divides a piece of music into a plurality of predetermined determination sections (for example, the music section described above), and sets a determination section satisfying a predetermined condition as a specific section. In this example, a determination section having a chord progression importance level exceeding a predetermined threshold value is set as the specific section by calculating the chord progression importance level in each determination section.

The chord progression importance level is calculated based on various data registered in the music database 159 and the chord progression in the determination section. An example of this calculation method will be described.

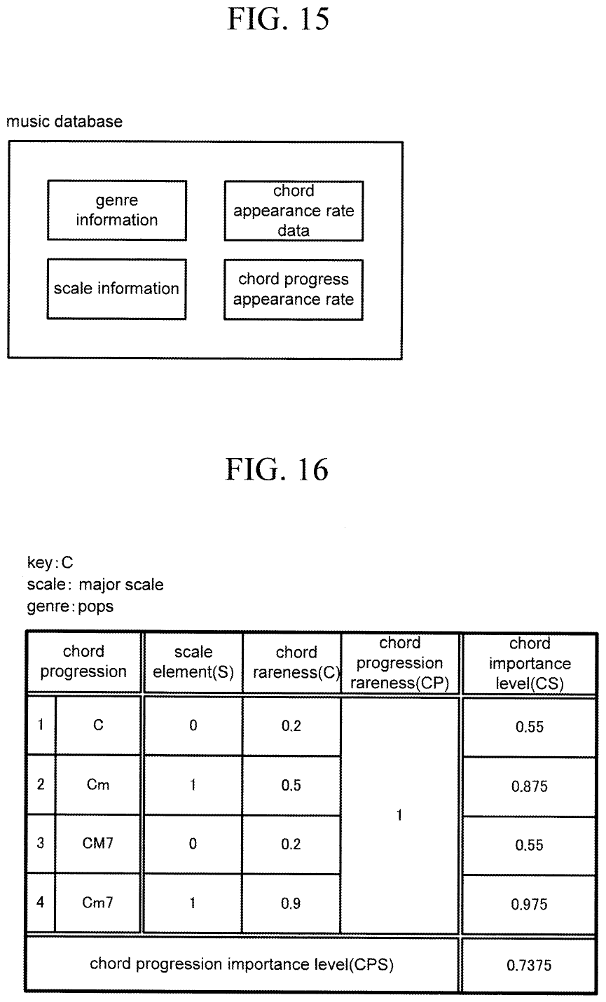

FIG. 15 is a diagram for explaining the music database according to an embodiment. The music database 159 is stored in the memory unit 15 of the text providing server 1, for example. In the music database 159, information on a plurality of music is registered, and, for example, genre information, scale information, chord appearance rate data, and chord progression appearance rate data associated with each other are registered.

The genre information is, for example, information indicating a genre of music such as “rock”, “pop”, and “jazz”. The scale information is information indicating scales called “C major scale”, “C minor scale”, “C #major scale”, (including keys in this embodiment). In each scale, a sound constituting the scale (hereinafter, referred to as a scale constituent note) is set.

The chord appearance rate data indicates a ratio of each type of chord to the total number of chords of all the music registered in the music database 159. For example, if the total number of chords is “10000” and the number of chords “Cm” is “100”, the appearance rate of the chords is “0.01”.

When calculating the appearance rate of the chord, any of the following determination criteria may be used for an identity of chords similar to each other. Chords having different names may be treated as different chords (“CM7” and “C/B” are different). If the chord tones are the same, they may be treated as the same chords (“CM7” and “C/B” are same). If the chord tones and the bass note are the same as each other, they may be treated as the same chords (“CM7” and “G/C” are the same). Even if the chord tones are different from each other, the same chords may be used as long as they are the same except for the tension notes (“CM7” and “C” are the same).

The chord progression appearance rate data indicates a ratio of a chord progression of each type to a total number of chord progressions of all the music registered in the music database 159. Here, the chord progression is set in advance by the user or the like. For example, if the total number of chord progressions is “20000” and a number of chord progressions “Dm-G7-CM7” is “400”, the appearance rate of chord progressions is “0.02”.

The determination criteria of the identity of the chord may be the same as the method for determining the chord appearance rate described above. As the determination criteria of the identity of the chord progression, any of the following criterions may be used. Chord progressions that are similar to each other may be treated as the same chord progression. For example, a derived form for the base form and the form using the tritone substitution shown in FIG. 10 may be treated as the same chord progression.

Chord progressions, in which at least two of the chord progressions match, may be treated as the same chord progression. For example, if the chord progression is “Dm-G7-CM7”, “*-G7-CM7”, “Dm-*-CM7”, and “Dm-G7-*” may be treated as the same chord progression. Here, “*” indicates an unspecified chord (any of all chords).

The chord appearance rate data and the chord progression appearance rate data include data for all music. In this example, the chord appearance rate data and the chord progression appearance rate data further include data determined corresponding to each genre defined in the genre information. For example, the chord appearance rate data and the chord progression appearance rate data corresponding to the genre “rock” may include the appearance rate of the chord and the appearance rate of the chord progression obtained only from the music corresponding to the genre “rock”. A parameter of the appearance rate (the total number of chords and the total number of chord progressions) may be data for all of the music may be used.

Regarding chord and chord progression, an appearance rate in the genre “rock” is different from an appearance rate in the genre “jazz”. Therefore, since the appearance rate of the chord and the appearance rate of the chord progression present for each genre, it is possible to more accurately determine the characteristic part of the music. The genre information may not necessarily be used, and in this case, the chord appearance rate data and the chord progression appearance rate data for each genre may not be present.

FIG. 16 is a diagram for explaining a method of calculating the chord progression importance level. In an example shown in FIG. 16, an index value and the importance level in the case where the chord progression in the determination section is “C-Cm-CM7-Cm7” are shown. The index value includes a chord progression rareness (CP) determined with respect to the chord progression, a scale element (S) determined with respect to the respective chords constituting the chord progression, and a chord rareness (C). Based on these indices, a chord importance level (CS) for the respective chords and a chord progression importance level (CPS) for the chord progression are calculated. The index value and the importance level each have a value in the range of “0” to “1”. A higher value indicates a characteristic element.

In this case, for the music, the key is C, the scale is a major scale, and the genre is pops. These pieces of information may be set in advance by the user or may be set by analyzing the music chord data. In the case where the music chord data is analyzed, for example, the pieces of information may be set in relation to a similar chord by comparison with a piece of music registered in the music database 159, or may be estimated from a sequence of chords using a trained model obtained by machine learning or the like.

The scale element (S) is set to “0” in the case where all of the chord tones are included in the scale constituent notes, and is set to “1” in the case where any of the chord tones are not included in the scale constituent notes. This is because a chord including a sound not included in the scale constituent note can be said to be a characteristic part of a piece of music.

The chord rareness (C) is obtained by a predetermined calculation formula. The calculation formula is determined so that the chord rareness (C) decreases as the chord appearance rate increases. In the case of a C major scale, C and CM7 have a relatively high chord appearance rate, so that the chord rareness (C) is set to a relatively low value.

The chord progression rareness (CP) is obtained by a predetermined calculation formula. The calculation formula is determined so that the chord progression rareness (CP) decreases as the chord progression appearance rate increases. In this case, since the appearance rate of the chord progression “C-Cm-CM7-Cm7” is extremely low, the chord progression rareness (CP) is set to “1” which is a large value.

The chord importance level (CS) is calculated using the scale element (S), the chord rareness (C) and the chord progression rareness (CP). In this case, the calculation formula is CS=a×S+b×C+c×CP, a=¼, b=¼, c=½. The chord progression importance level (CPS) is the mean of the chord importance level (CS).

The chord progression importance level (CPS) obtained in this way indicates that the larger the numerical value (closer to “1”), the rarer the chord progression compared to other music. That is, a determination section having a large chord progression importance level (CPS) is a characteristic part of music.

The method of calculating the index value and the importance level described above is an example, and various calculation methods can be used as long as the importance level of the chord progression (that is, a characteristic part of the music) is obtained. Next, a method of generating chord input data using a specific section will be described. For example, the process of the step S103 shown in FIG. 2 is replaced with this method of generating the chord input data.

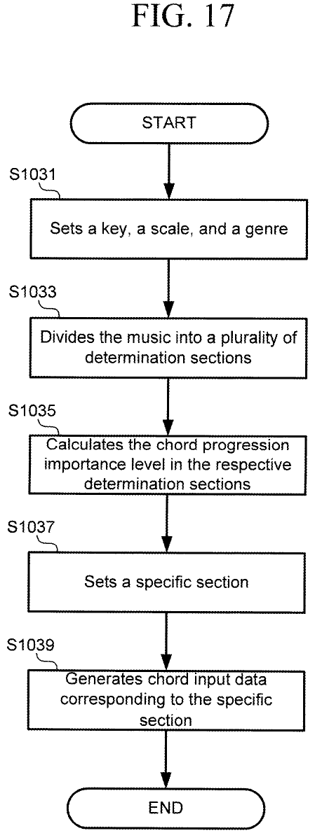

FIG. 17 is a flowchart showing a process of generating chord input data according to an embodiment. The control unit 11 sets a key, a scale, and a genre (step S1031). As described above, the key, the scale, and the genre may be acquired by receiving the key, the scale, and the genre from the communication terminal 9 based on a setting by the user, or may be acquired by analyzing the music chord data. The control unit 11 divides the music into a plurality of determination sections (step S1033), and calculates the chord progression importance level (CPS) in the respective determination sections (step S1035).

The control unit 11 sets at least one determination section as a specific section on the basis of the chord progression importance level (CPS) calculated for the respective determination sections (step S1037). In this embodiment, a determination section in which the chord progression importance level (CPS) is larger than a predetermined threshold is set as a specific section. A predetermined number of determination sections in order from the determination section having the largest chord progression importance level (CPS) may be set as the specific sections.

The control unit 11 generates chord input data corresponding to the specific section (step S1039). In the chord input data, one specific section may be arranged in one divided region by providing the end marker EOS for each specific section, or in the case where a plurality of consecutive determination sections is set as a plurality of specific sections, the plurality of specific sections may be arranged so as to be included in one divided region.

In this way, by providing the generated chord input data to the trained model 155, the trained model 155 can generate explanatory text for the chord progression representing the characteristic part of the music, and output the text output data.

### 6. Modification

The present disclosure is not limited to the embodiment described above, and includes various other modifications. For example, the embodiments described above have been described in detail to show the present disclosure in an easy-to-understand manner, and are not necessarily limited to those having all the described configurations. In the embodiment, other configurations may be added, one or more configurations are deleted, or substituted for some of the configurations. Some modification examples will be described below.
(1) In the embodiment described above, the text providing server 1 uses the trained model 155 to generate the explanatory text from the chord input data, but may use a model (for example, a rule-based model) that does not use a neural network. According to the trained model 155, it is possible to improve accuracy of the explanatory text by using many teacher data sets 355 in the machine learning.

According to the rule-based model, it is necessary to set a rule for generating the explanatory text from the chord input data, that is, a correspondence relationship between information corresponding to the chord sequence data 357 and information corresponding to the explanatory text data 359. This rule requires a large amount of information. For example, as described above, various types of a sequence of chords determined as a II-V-I chord progression are assumed. Therefore, in order to increase the accuracy of the explanatory text, it is necessary to set respective explanatory texts corresponding to many types of the sequence of chords that can be assumed. In order to reduce the amount of information, it may be necessary to simplify the explanatory text as compared with the case where the trained model 155 is used. Although it is assumed that an efficiency is lower than in the case of using the trained model 155, it is feasible to generate the explanatory text from chord input data by the rule-based model.
(2) The chord appearance rate data and the chord progress appearance rate data may be defined to be equivalent regardless of the key of a piece of music. For example, the chord appearance rate data may be defined such that the chord “CM7” when the key of a piece of music is “C” and the chord “EM7” when the key is “E” of a piece of music are interpreted as the same chord. The chord progression appearance rate data may be defined such that the chord progression “Dm-G7-CM7” when the key of a piece of music is “C” and the chord progression “Fm-B7-EM7” when the key of a piece of music is “E” are interpreted as the same chord progression.

That is, the chord appearance rate data and the chord progression appearance rate data may each be defined by a chord of a relative expression for a key of a piece of music. The relative expression may be converted to the chord, for example, when the key is “C”. It may be converted into a description such as “I” or “II”. For example, the chord “Em7” when the key is “C” is expressed as “IIIm7”.

In this case, the control unit 11 converts the chord appearance rate data and the chord progression appearance rate data defined by the chord of the relative expression into a chord of an absolute expression based on the key of the set music. The control unit 11 calculates the chord importance level (CS) and the chord progression importance level (CPS) based on the appearance rate of the converted chord.
(3) Instead of using the trained model 155, the text providing server 1 may use an arithmetic model such as SVM (Support Vector Machine) or HMM (Hidden Markov Model). In this case, the control unit 11 acquires a specific chord progression, for example, “II-V-I” from the chord input data using the arithmetic model. The control unit 11 combines the acquired chord progression and a predetermined template, thereby generating explanatory text. The predetermined template, for example, “XXXX is used for this chord progression.” By applying the acquired chord progression (in the above example, “II-V-I”) in the “XXXX” part, explanatory text “II-V-I which is used for this chord progression” is generated. In the case of HMM, the chords included in the chord input data may be sequentially input. In the case of SVM, a predetermined number of chords included in the chord input data may be collectively input.
(4) Servers that store a plurality of trained models 155 may be connected to the network NW. The server may be the model generating server 3. The text providing server 1 may select one of the plurality of trained models 155 stored in the server and execute the text providing process described above. The text providing server 1 may download the trained model 155 used in the text providing process from the server and store it in the memory unit 15, or may transmit the chord input data by communicating with a server, that stores the trained model 155, without downloading it, and receive the text output data.

In the plurality of trained models 155, at least a part of the teacher data sets 355 used in machine learning are different from each other. For example, when machine learning is performed using the plurality of teacher data sets 355 classified by genres (jazz, classic, or the like), a plurality of trained models 155 corresponding to the plurality of genres are generated. The teacher data sets 355 may be classified according to a genre type, or may be classified according to a musical instrument type. According to this classification, the chord sequence data and the explanatory text data are specialized for the classification. The teacher data sets 355 may be classified by a creator of the explanatory text included in the explanatory text data 359.

For example, by providing the trained model 155 corresponding to jazz with chord input data corresponding to a piece of music classified into jazz, it is possible to obtain explanatory text with high accuracy. A target for classifying a piece of music corresponding to the chord input data may be set by the user or may be set by analyzing the music.

A plurality of types of explanatory texts may be obtained by providing one chord input data to the plurality of trained models 155. For example, if a plurality of trained models 155 corresponding to a plurality of creators are used, a plurality of types of explanatory texts are obtained and can be compared to select one suitable for the user. Among the explanatory texts obtained from the plurality of trained models 155, a new explanatory text may be generated based on a common point.
(5) The chord input data and the chord sequence data 357 are not limited to the cases described by the chroma vectors. For example, if the chord tone is represented by data including a vector, the chord tone may be represented by another method. Chords may also be described in terms of “word2vec”, “GloVe”, or the like.

The above is the description of the modifications.

As described above, according to an embodiment of the present disclosure, there is provided a text providing method including obtaining text corresponding to chord input data, in which chords are aligned in chronological order, based on a relationship between chord sequence data, in which chords are aligned in chronological order, and explanatory text related to chords included in the chord sequence data.

Obtaining the text may include obtaining the text from the trained model by providing the chord data to a trained model that has learned the relationship.

The chord input data may include at least a chord tone and a bass note of the chord corresponding to the chord input data.

The chord input data may include at least a chord tone and a tension note of the chord corresponding to the chord input data.

The chord input data may include a vector data.

The chord input data may include a first chroma vector corresponding to a chord tone of a chord corresponding to the chord input data.

The chord input data may include a second chroma vector corresponding to a bass note of a chord corresponding to the chord input data.

The chord input data may include a third chroma vector corresponding to a tension note of a chord corresponding to the chord input data.

The text, corresponding to the chord input data, obtained from the trained model may include explanatory text including a first character group describing the chord progression of chords corresponding to the chord input data.

The text, corresponding to the chord input data, obtained from the trained model may include explanatory text including a second character group describing respective functions of the chords corresponding to the chord input data.

The text, corresponding to the chord input data, obtained from the trained model may include explanatory text including a third character group describing the concatenation technique between chords corresponding to the chord input data.

The method may include obtaining music chord data, in which the chords of the piece of music are aligned in chronological order, and extracting a sequence of the chords, in a specific section of the piece of the music satisfying a predetermined condition, from the music chord data as the chord input data.

The predetermined condition may include a condition using the chord included in the music chord data and an importance level related to a chord determined according to a key of the music.

The predetermined condition may include a condition using the chord included in the music chord data and an importance level related to a chord determined according to a genre of the music.

A program for causing a computer to execute the text providing method may be provided. A text providing device including a memory unit storing instructions of the program and a processor executing the instructions may be provided.

What is claimed is:

1. A text providing method comprising:
providing chord input data to a trained model, the trained model having learned a relationship between chord sequence data in which chords are aligned in chronological order, and explanatory text about the chords included in the chord sequence data; and
obtaining text corresponding to the chord input data from the trained model.

2. The text providing method according to claim 1, wherein the chord input data includes vector data.

3. The text providing method according to claim 1, wherein the chord input data includes a chroma vector corresponding to a chord tone of a chord corresponding to the chord input data.

4. The text providing method according to claim 1, wherein the chord input data includes a chroma vector corresponding to a bass note of a chord corresponding to the chord input data.

5. The text providing method according to claim 1, wherein the chord input data includes a chroma vector corresponding to a tension note of a chord corresponding to the chord input data.

6. The text providing method according to claim 1, wherein the text, corresponding to the chord input data, obtained from the trained model includes explanatory text including a character group describing a chord progression of chords corresponding to the chord input data.

7. The text providing method according to claim 1, wherein the text, corresponding to the chord input data, obtained from the trained model includes explanatory text including a character group describing respective functions of chords corresponding to the chord input data.

8. The text providing method according to claim 1, wherein the text, corresponding to the chord input data, obtained from the trained model includes explanatory text including a character group describing a concatenation technique between chords corresponding to the chord input data.

9. The text providing method according to claim 1, further comprising:
obtaining music chord data in which chords of a piece of music are aligned in chronological order; and
extracting a sequence of the chords, in a specific section of the piece of music satisfying a predetermined condition, from the music chord data as the chord input data.

10. The text providing method according to claim 9, wherein:
the specific section of the music satisfies the predetermined condition in a case where an importance level of the sequence of the chords, in the specific section of the music, exceeds a threshold value, and
the importance level of the sequence of the chords is determined based on respective index values of chords included in the sequence of chords, the respective index values being determined, at least in part, according to a key of the peace of the music.

11. The text providing method according to claim 9, wherein:
the specific section of the music satisfies the predetermined condition in a case where an importance level of the sequence of the chords, in the specific section of the music, exceeds a threshold value, and
the importance level of the sequence of the chords is determined based on respective index values of chords included in the sequence of chords, the respective index values being determined, at least in part, according to a genre of the piece of the music.

12. A text providing device comprising,
a control unit including a processor and a memory,
wherein the control unit is configured to obtain text corresponding to chord input data, in which chords are aligned in chronological order, based on a relationship between chord sequence data, in which chords are aligned in chronological order, and explanatory text related to the chords included in the chord sequence data.

13. The text providing device according to claim 12, wherein
the control unit is further configured to obtain the text from a trained model by providing the chord input data to the trained model, the trained model having learned the relationship between the chord sequence data and the explanatory text related to the chords included in the chord sequence data.

14. The text providing device according to claim 12, wherein the chord input data includes at least a chord tone of a chord corresponding to the chord input data and a bass note of the chord corresponding to the chord input data.

15. The text providing device according to claim 12, wherein the chord input data includes at least a chord tone of a chord corresponding to the chord input data and a tension note of the chord corresponding to the chord input data.

16. The text providing device according to claim 12, wherein the chord input data includes a vector data.

17. The text providing device according to claim 12, wherein the chord input data includes a chroma vector corresponding to a chord tone of a chord corresponding to the chord input data.

18. The text providing device according to claim 12, wherein the chord input data includes a chroma vector corresponding to a bass note of a chord corresponding to the chord input data.

19. The text providing device according to claim 12, wherein the chord input data includes a chroma vector corresponding to a tension note of a chord corresponding to the chord input data.

20. The text providing device according to claim 12, wherein the obtained text corresponding to the chord input data includes explanatory text including a character group describing a chord progression of chords corresponding to the chord input data.
